(19) United States
(12) Patent Application Publication
(10) Pub. No.: US 2019/0131875 A1
(43) Pub. Date: May 2, 2019

(54) PRESERVING PHASE INTERLEAVING IN A HYSTERETIC MULTIPHASE BUCK CONTROLLER

(71) Applicant: Renesas Electronics America Inc., Milpitas, CA (US)

(72) Inventors: Gaurav BAWA, Bridgewater, NJ (US); Mir MAHIN, Jamison, PA (US)

(73) Assignee: Renesas Electronics America Inc., Milpitas, CA (US)

(21) Appl. No.: 16/168,596

(22) Filed: Oct. 23, 2018

Related U.S. Application Data
(60) Provisional application No. 62/578,602, filed on Oct. 30, 2017.

(51) Int. Cl. H02M 3/158; H02M 1/08; G05F 1/613

(52) U.S. Cl. CPC H02M 3/1582; G05F 1/613; H02M 1/08

(57) ABSTRACT

The present embodiments relate generally to DC-DC converters, and more particularly to methods and apparatuses for preservation of phase-interleaving in a hysteretic multiphase buck controller. In one or more embodiments, a notch filter is placed in the compensation loop. The notch frequency can be adjusted to match the switching frequency of the controller, and automatically tuned to account for changes to the switching frequency introduced by controller RC components. According to additional aspects, phase interleaving is preserved even during large duty cycles.

### CROSS-REFERENCE TO RELATED APPLICATIONS

The present application claims priority to U.S. Provisional Patent Appln. No. 62/578,602, filed Oct. 30, 2017, the contents of which are incorporated by reference herein in their entirety.

### TECHNICAL FIELD

The present embodiments relate generally to DC-DC converters, and more particularly to methods and apparatuses for preservation of phase interleaving in a hysteretic multiphase buck controller.

### BACKGROUND

Hysteretic controllers for multiphase DC-DC converters employ internal modulators for controlling interleaving of the multiple phases. One benefit of such types of controllers is that they provide for rapid response to load step by permitting all phases to operate concurrently. However, challenges arise in other situations where more stable phase interleaving (e.g., 180° for two phases) is desired.

### SUMMARY

The present embodiments relate generally to DC-DC converters, and more particularly to methods and apparatuses for preservation of phase-interleaving in a hysteretic multiphase buck controller. In one or more embodiments, a notch filter is placed in the compensation loop. The notch filter frequency can be adjusted to match the switching frequency of the controller, and automatically tuned to account for changes to the switching frequency introduced by controller RC components. According to additional aspects, phase interleaving is preserved even during large duty cycles.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a block diagram illustrating an example multiphase buck controller;

FIG. 2A is a block diagram illustrating an example compensator and window generator that can be included in the controller of FIG. 1;

FIG. 2B is a block diagram illustrating an example PWM generator that can be included in the controller of FIG. 1;

FIG. 3 includes transient response diagrams illustrating broken phase interleaving that can occur in a controller such as that shown in FIG. 1;

FIG. 4 is a block diagram illustrating an example multiphase buck controller according to embodiments;

FIG. 5 includes transient response diagrams illustrating preserved phase interleaving provided by a controller such as that shown in FIG. 4;

FIG. 6 is a block diagram of an example notch filter for including in a controller such as that shown in FIG. 4 according to embodiments; and

FIG. 7 is a functional block diagram of how notch filter frequency is adjusted in accordance with controller switching frequency in an example embodiment.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

According to certain aspects, the present embodiments are directed to preserving phase interleaving in a hysteretic multiphase buck controller. In one or more embodiments, a notch filter is placed in the compensation loop so as to prevent ripple from being introduced into the window voltages. There is little or no impact to the closed-loop bandwidth and hence the transient response of the controller due to the notch filter. Advantageously, however, interleaving is preserved for large duty cycles and in other conditions where phase interleaving can break. In these and other embodiments, the notch filter is configured to be tuned in accordance with an actual switching frequency of the controller.

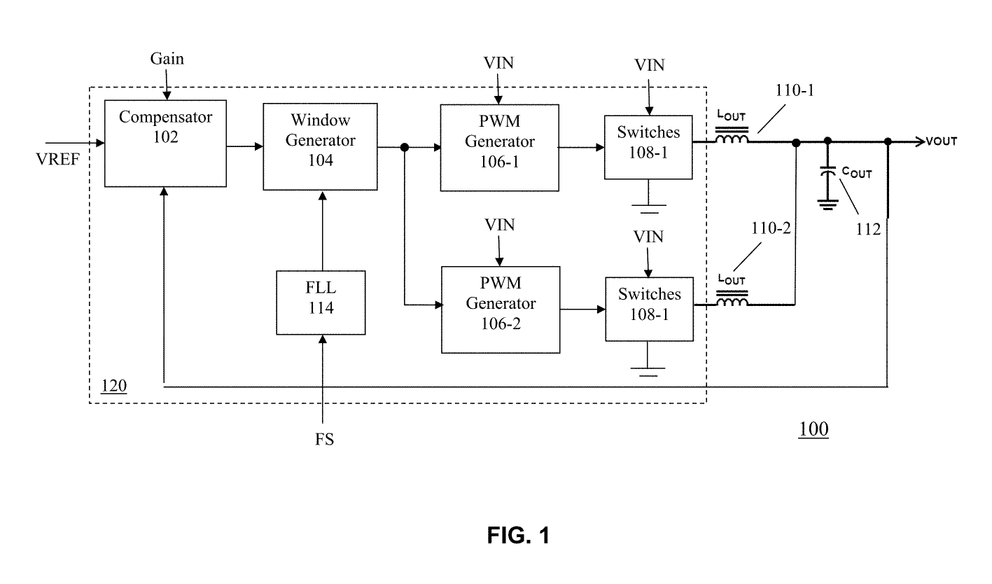

FIG. 1 is a block diagram illustrating an example multiphase power controller 100. In general, controller 100 controls the supply of a regulated voltage VOUT based on a received input voltage VIN. The present embodiments will be described in connection with an example where VIN is typically higher than VOUT, in which case controller 100 operates in a buck mode. However, aspects of the present embodiments are not necessarily limited to this example.

As further shown in the example of FIG. 1, controller 100 includes two phases, each with respective pulse width modulation (PWM) generators 106, switches 108 and inductors LOUT 110. However, the present embodiments are not limited to this example number of phases, and the principles herein can be extended to any number of N phases. As further shown in FIG. 1, controller 100 includes a compensator 102 and a window generator 104. In general operation to be described in more detail below, controller 100 uses the output voltage VOUT that is fed back to compensator 102 to adjust the PWM signals provided to switches 108 in order to cause VOUT to maintain a regulated target voltage that is based on VREF and compensation gain (Gain). The PWM signals have a switching frequency whose target is set by FLL 114 based on a programmable input FS (the actual switching frequency can vary as will be described in more detail below). Switches 108 can be implemented using power MOSFETs as are well known in the art.

As yet further shown in the example of FIG. 1, controller 100 can be mainly implemented by a single integrated circuit 120, in which case inductors LOUT 110 and capacitor COUT 112 are implemented as externally connected components. In this example, the compensation gain (Gain) and the switching frequency FS can be provided by external components, based on a desired VOUT for a given VIN, for example. It should be noted that other implementations, including less or more integrated implementations, are possible.

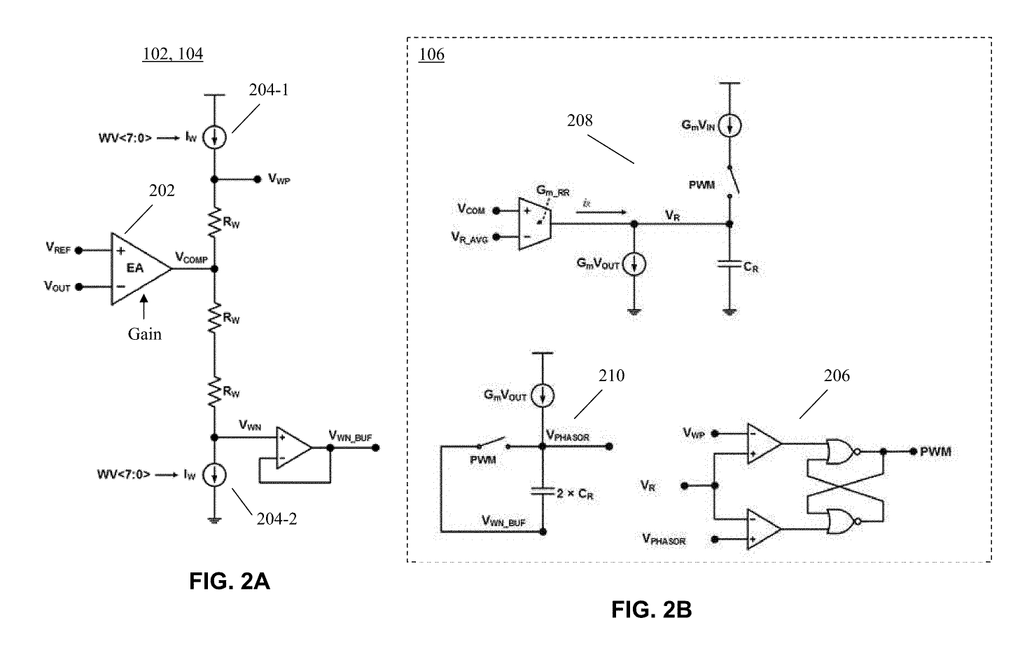

An example implementation of compensator 102 and window generator 104 is shown in FIG. 2A. As shown in this example, compensator 102 is implemented by an error amplifier 202 that produces an error signal VCOMP based on the difference between VREF and VOUT and the compensator gain (Gain). Window generator 104 in this example includes programmable current sources 204 and resistors RW that establish window voltages VWP and VWN respectively offset from VCOMP in accordance with a current from sources 204 that is based on an 8-bit input signal WV<7:0> from FLL 114.

An example implementation of PWM generator 106 is illustrated in FIG. 2B. Referring back to FIG. 1, although only one PWM generator 106 is shown in FIG. 2B, there can be one PWM generator 106 for each of the N phases of controller 100 (e.g., N=2). As shown in this example, PWM generator 106 includes a duty cycle generator 212 that produces the PWM output signal having the appropriate duty cycle D by comparing a ramp signal VR to the window voltages established by VWP (from window generator 104) and VPHASOR. In this example, VR is produced by ramp signal generator 214 based on the voltage established by ramp capacitor CR, which is charged and discharged by current sources whose currents are controlled by Gm, VIN and VOUT. In other words, the level and slope of the ramp signal VR (and thus the duty cycle and actual switching frequency of the PWM signal) will depend on the values of CR, Gm, VIN and VOUT. Although the lower window voltage VWN from window generator 104 is adjusted to VPHASOR by phasor generator 216 as shown in this example, this is not always necessary, and ramp signal generator 212 can use the window voltages VWN and VWP in other embodiments.

The present applicant recognizes several issues in connection with the example implementations of compensator 102, window generator 104 and PWM generator 106 of controller 100 illustrated in connection with FIGS. 2A and 2B. For example, as will be appreciated by those skilled in the art, the examples of FIGS. 2A and 2B implement a hysteretic multiphase controller, in which phase interleaving is not fixed by external signals such as clock signals. As such, for a two-phase application, phase interleaving can deviate from 180° (in the ideal case) to 0° (in the worst case, i.e. phase interleaving “breaks”) for large duty cycles (e.g., D>0.25) in some situations. The present applicants have discovered that this is because there is a strong impact of the VOUT ripple (which depends on the LC tank formed by the output inductors LOUT and the output capacitor COUT) and the compensation gain (Gain) to the VCOMP signal. Both of these parameters can be programmed by the user (e.g., by selection of particular values of external components LOUT and COUT) based on the particular end application. It should be noted that phase interleaving can also break in other situations even where D<0.25 if a large ESR based COUT is used (e.g., if bulk capacitors are employed instead of ceramic capacitors).

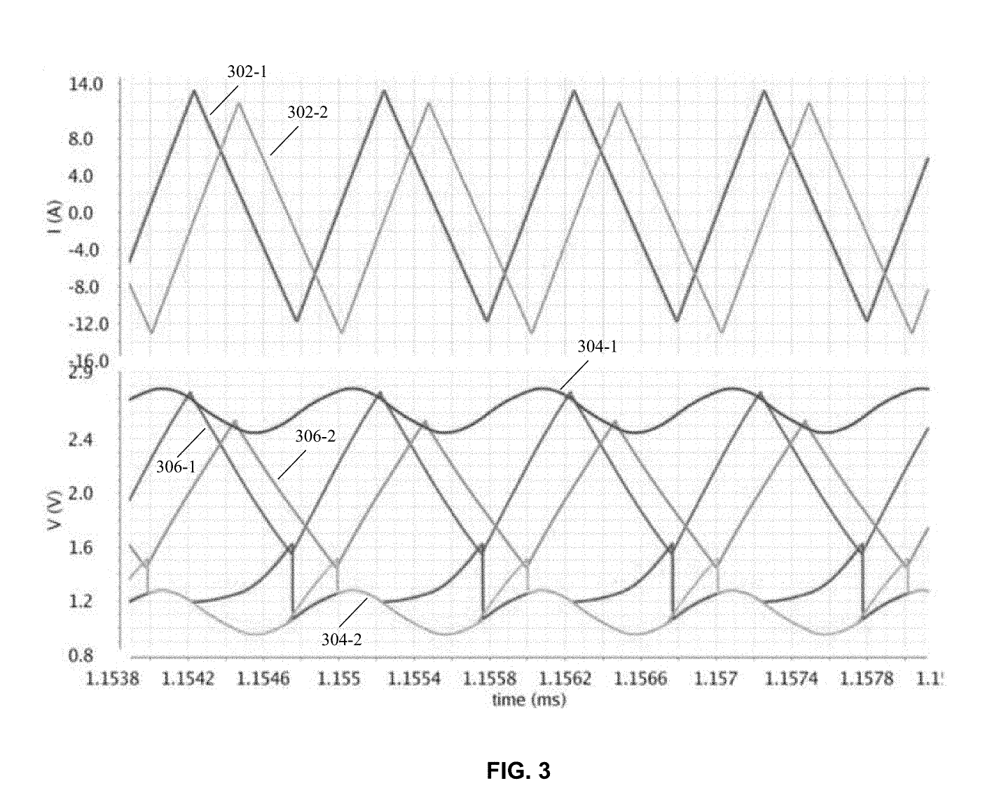

FIG. 3 are transient response diagrams showing the interleaving problem in an example implementation of a two-phase controller such as that shown in FIG. 1, when the VIN to VOUT ratio is 12V to 5V (i.e. D=0.417). Curves 304-1 and 304-2 illustrate the high and low window voltages, respectively, and curves 306-1 and 306-2 illustrate the ramp voltages for the first and second phases, respectively. As set forth above, depending on the duty ratio, the compensation gain and the LC tank, strong ripple may be introduced in the VCOMP signal. The strong ripple exhibits itself in the window voltages, which when compared to the ramp voltages, causes breakdown of phase interleaving, as can be seen in the inductor current curves 302-1 and 302-2 for the first and second phases, respectively. Accordingly, the present applicants recognize a need for a multiphase controller solution that preserves phase interleaving for arbitrary LC tank and compensation parameters.

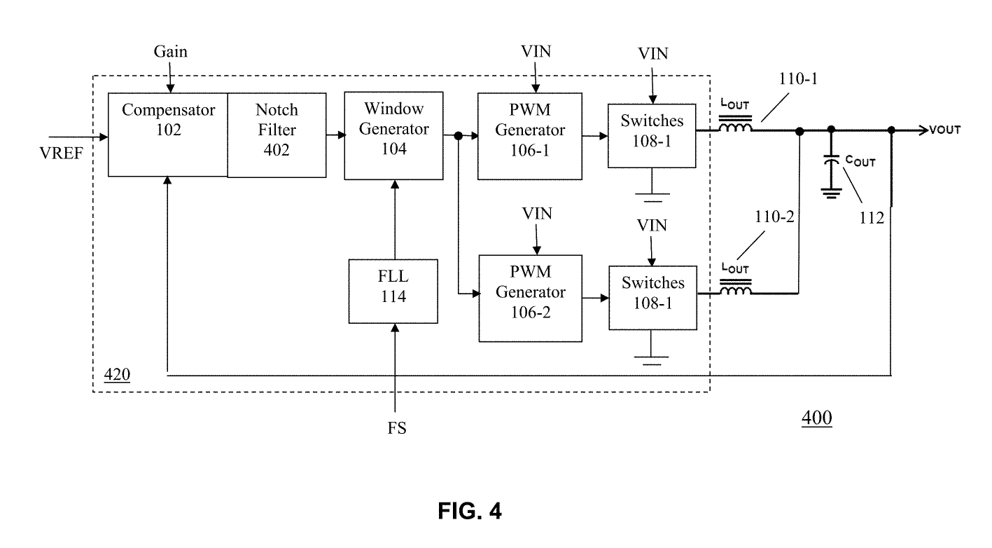

FIG. 4 is a block diagram of an example controller 400 according to embodiments. As shown in this example, the compensator 102 of controller 400 includes or is coupled to a notch filter 402. As will be explained in more detail below, the present applicant has discovered that providing such a notch filter 402 in the compensation loop, and more particularly in the signal path of the VCOMP output by compensator 102, can reduce the propagation of ripple into the window voltages, thereby preserving phase interleaving even for large duty cycles (e.g., D>0.25). As explained in more detail below, the notch filter 402 is preferably tuned in accordance with an actual switching frequency of the controller.

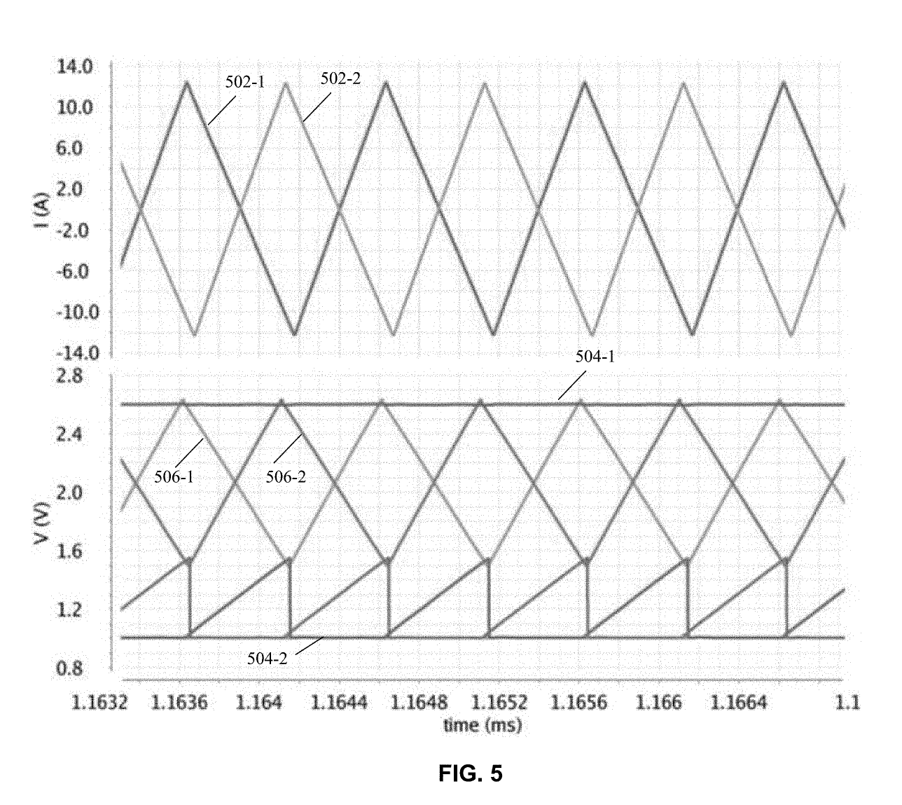

FIG. 5 are transient response diagrams illustrating preserved phase interleaving in a two-phase controller such as that shown in FIG. 4 according to the present embodiments, when D>0.25. As shown in this example, differently from the situation shown in FIG. 3, the window voltages 504-1 and 504-2 do not exhibit ripple, allowing a cleaner comparison with the ramp voltages 506-1 and 506-2, and thereby preserving 180° phase interleaving in the resulting current waveforms 502-1 and 502-2.

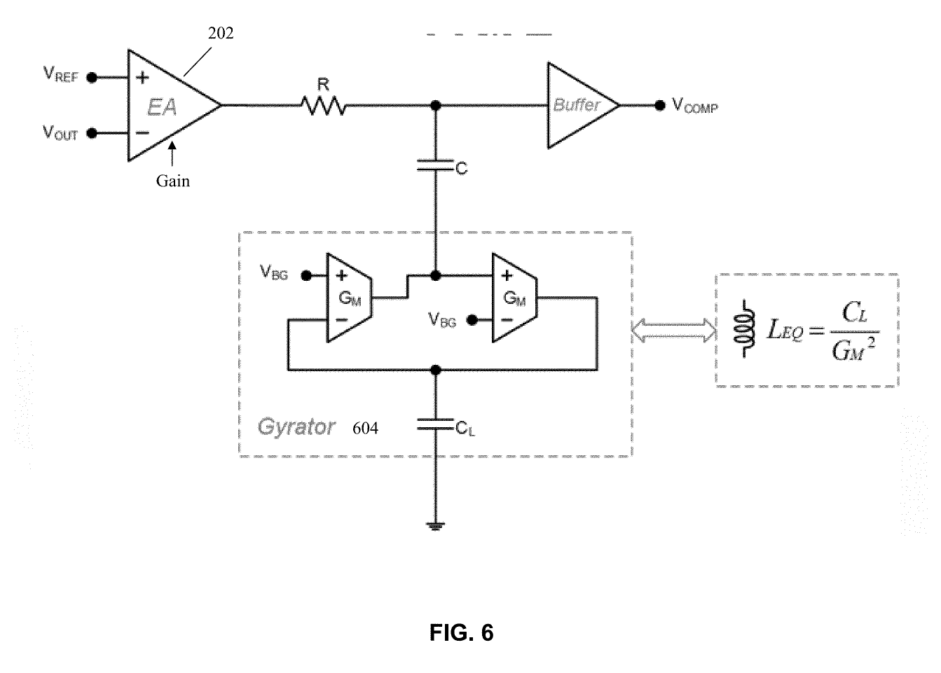

FIG. 6 is a block diagram illustrating an example implementation of notch filter 402 according to embodiments. As can be seen, the notch filter is placed in the compensation loop for filtering the VCOMP output from error amplifier 202, which implements compensator 102. As such, there is little or no impact in the closed-loop bandwidth, and hence the transient response, of controller 402.

As shown in this example, in addition to components R and C (whose values can be adjusted as described in more detail below), notch filter 402 includes a gyrator 602, which is designed as described in more detail below to have an equivalent inductance LEQ 604 (as determined by the values of G_{M} and C_{L} in gyrator 602). The transfer function H_{NOTCH}(s) for the example implementation of notch filter 402 shown in FIG. 6 can be expressed as follows.

$${H}_{NOTCH} ( s ) = \frac{1 + {s}^{2} {L}_{EQ} C}{1 + {s}^{2} {L}_{EQ} C + sRC}$$

From this transfer function, the resonant frequency of notch filter 402 can be derived as follows.

$${ω}_{n} = \frac{1}{\sqrt{{L}_{EQ} C}} = \frac{{G}_{M}}{\sqrt{{C}_{L} \times C}}$$

Likewise, the Q factor of notch filter 402 can be derived from the transfer function as follows.

$$Q = \frac{1}{R} \sqrt{\frac{{L}_{EQ}}{C}} = \frac{1}{{G}_{M} \times R} \sqrt{\frac{{C}_{L}}{C}}$$

According to aspects to be described in more detail below, to accomplish the results shown in FIG. 5, the resonant frequency of notch filter 402 (i.e., f_{NOTCH}=ωₙ/2π) is adjusted to match the switching frequency f_{SW} of controller 420, subject to a fixed value of Q (e.g., Q=0.8), by dynamically adjusting the values of G_{M}, C_{L}, C and R in accordance with, and in response to, changes in the switching frequency f_{SW}. Put another way, the values of the components in notch filter 402 are adjusted to match the RC components of PWM generator 106, so as to mimic the changes in the actual switching frequency f_{SW} introduced by the RC components of PWM generator 106.

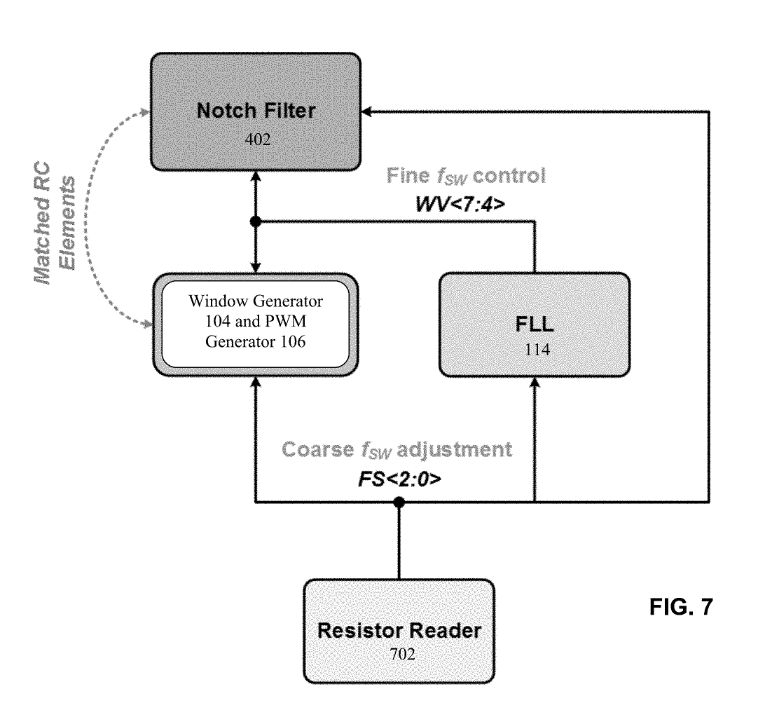

FIG. 7 is a functional block diagram of an example embodiment, showing the functional interactions between the notch filter 402 and other controller 420 components. As shown in FIG. 7, and with reference to the example controller 420 of FIG. 4, FLL 114 receives the target switching frequency FS from a resistor reader 702, which can be connected to an externally arranged resistor, whose value is selected in accordance with a predetermined target switching frequency of the controller 420. The programmed FS value (3 bits in this instance) is used as a target f_{SW} for FLL 114 and is also provided to notch filter 402 as a coarse adjustment for f_{NOTCH}. FLL 114 produces the digital output WV<7:0> based on the target f_{SW} and the top 4 bits of this output WV<7:4> are used as a fine adjustment for f_{NOTCH}. As such, the notch filter frequency f_{NOTCH} will track the actual switching frequency of the PWM signal produced by PWM generator 106, which is based on the target switching frequency specified by FS and altered to the actual switching frequency f_{SW} based on the RC components of the PWM generator 106.

Examples of how the coarse adjustment for f_{NOTCH} and the fine adjustment for f_{NOTCH} are implemented are as follows. As will be appreciated, in the example set forth above, there are only 8 possible values of FS<2:0> and 16 possible values of WV<7:4>. Accordingly, predetermined sets of resistors and capacitors can be included in notch filter 402 and selectively switched into the circuit of notch filter 402 based on the corresponding predetermined values of FS<2:0> and WV<7:4>. More particularly, based on the particular value of FS<2:0>, one of 8 predetermined resistance values is selected for inclusion in gyrator 602 (e.g., implemented by voltage-controlled switches that are interconnected by adjustable resistances), to thereby correspondingly change the values of G_{M} and R in notch filter 402 and implement a coarse adjustment to f_{NOTCH} based on the target switching frequency f_{SW}. Likewise, based on the particular value of WV<7:4>, one of 16 predetermined capacitance values is selected for inclusion in gyrator 602 and notch filter 402, to thereby correspondingly change the values of C_{L} and C and implement a fine adjustment to f_{NOTCH} based on the actual switching frequency f_{SW} as caused by the RC components of PWM generator 106. The predetermined sets of resistance and capacitance values can be pre-computed to provide a combined fixed value of Q (e.g., Q=0.8) based on the above equations described in connection with the example notch filter 402 shown in FIG. 4.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A DC-DC controller, comprising:
a compensation loop including an error amplifier that receives a feedback voltage corresponding to an output voltage of the DC-DC controller and generates a compensation signal based on the feedback voltage;
a plurality of PWM generators corresponding to a plurality of phases, the PWM generators controlling respective currents in the phases based on the compensation signal; and
a notch filter in the compensation loop.

2. The apparatus of claim 1, wherein the notch filter is tuned in accordance with an actual switching frequency of the DC-DC controller.

3. The apparatus of claim 2, wherein tuning is performed with respect to RC components of the PWM generators.

4. The apparatus of claim 2, wherein the actual switching frequency depends on a programmed frequency and the RC components.

5. The apparatus of claim 2, wherein tuning is performed by adjusting one or both of resistance and capacitance values in the notch filter.

6. The apparatus of claim 5, wherein the notch filter has a resonant frequency based on the resistance and capacitance values.

7. The apparatus of claim 1, wherein the compensation loop generates the compensation signal further based on a compensation gain.

8. The apparatus of claim 1, wherein the error amplifier further receives a reference voltage, the compensation signal being further based on a difference between the feedback voltage and the reference voltage.

9. The apparatus of claim 1, further comprising a window generator that generates upper and lower window voltages based on the compensation signal, the notch filter being operative to stabilize the compensation signal before it is received by the window generator.

10. The apparatus of claim 9, wherein the PWM generators use the upper and lower window voltages to control the respective currents in the phases.

11. The apparatus of claim 9, further comprising a frequency locked loop (FLL) that receives a programmed frequency and generates a signal based on the programmed frequency that the window generator uses to establish the upper and lower window voltages.

12. The apparatus of claim 11, wherein the notch filter is tuned in accordance with an actual switching frequency of the DC-DC controller, wherein the actual switching frequency depends on the programmed frequency and RC components of the PWM generators.

13. The apparatus of claim 12, wherein tuning is performed by adjusting one or both of resistance and capacitance values in the notch filter in accordance with the programmed frequency and the RC components.

14. The apparatus of claim 13, wherein the notch filter has a resonant frequency based on the resistance and capacitance values.

15. A method of operating a DC-DC controller, comprising:
receiving, by a compensation loop, a feedback voltage corresponding to an output voltage of the DC-DC controller
generating, by the compensation loop, a compensation signal based on the feedback voltage;
controlling, by a plurality of PWM generators corresponding to a plurality of phases, respective currents in the phases based on the compensation signal; and
tuning a notch filter in the compensation loop, in accordance with an actual switching frequency of the DC-DC controller.

16. The method of claim 15, wherein tuning is performed with respect to RC components of the PWM generators.

17. The method of claim 16, wherein the actual switching frequency depends on a programmed frequency and the RC components.

18. The method of claim 16, wherein tuning is performed by adjusting one or both of resistance and capacitance values in the notch filter.

19. The method of claim 18, wherein the notch filter has a resonant frequency based on the resistance and capacitance values.
